(19) United States
(12) Patent Application Publication
(10) Pub. No.: US 2010/0241984 A1
(43) Pub. Date: Sep. 23, 2010

(54) METHOD AND APPARATUS FOR DISPLAYING THE NON ALPHANUMERIC CHARACTER BASED ON A USER INPUT

(75) Inventors: Mikko Nurmi, Tampere (FI); Peter Dam Nielsen, Kgs Lyngby (DK); Christian Rossing Kraft, Frederiksberg C (DK)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/408,678

(22) Filed: Mar. 21, 2009

(51) Int. Cl. G06F 3/048; G06F 3/033

(52) U.S. Cl. 715/773; 715/863

(57) ABSTRACT

In accordance with an example embodiment of the present invention, an apparatus, comprising a shorthand-aided rapid keyboarding enabled touchscreen is configured to receive a user input. Further, a processor is configured to identify a position in a text input; and determine a non alphanumeric character based at least in part on the user input. Further still, the shorthand-aided rapid keyboarding enabled touchscreen is further configured to display the non alphanumeric character in the position.

### TECHNICAL FIELD

The present application relates generally to displaying the non alphanumeric character based on a user input.

### BACKGROUND

An electronic device has a user interface to use applications. Further, there may be different types of user interfaces. The electronic device facilitates application use using these different types of user interfaces.

### SUMMARY

Various aspects of examples of the invention are set out in the claims.

According to a first aspect of the present invention, an apparatus, comprising a shorthand-aided rapid keyboarding enabled touchscreen is configured to receive a user input. Further, a processor is configured to identify a position in a text input; and determine a non alphanumeric character based at least in part on the user input. Further still, the shorthand-aided rapid keyboarding enabled touchscreen is further configured to display the non alphanumeric character in the position.

According to a second aspect of the present invention, a method comprising receiving a user input on a shorthand-aided rapid keyboarding. The method further comprises identifying a position in a text input. Further, the method comprises determining a non alphanumeric character based at least in part on the user input. Further still, the method comprises displaying the non alphanumeric character in the position on the shorthand-aided rapid keyboarding enabled touchscreen.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram depicting a shorthand-aided rapid keyboarding enabled touchscreen operating in accordance with an example embodiment of the invention;

FIG. 3 is a block diagram depicting another shorthand-aided rapid keyboarding enabled touchscreen operating in accordance with an example embodiment of the invention;

FIG. 4 is a block diagram depicting yet another shorthand-aided rapid keyboarding enabled touchscreen operating in accordance with an example embodiment of the invention;

FIG. 5 is a block diagram depicting still yet another shorthand-aided rapid keyboarding enabled touchscreen operating in accordance with an example embodiment of the invention; and

FIG. 6 is a flow diagram depicting an example method 600 for display a non alphanumeric character in accordance with an example embodiment of the invention.

### DETAILED DESCRIPTON OF THE DRAWINGS

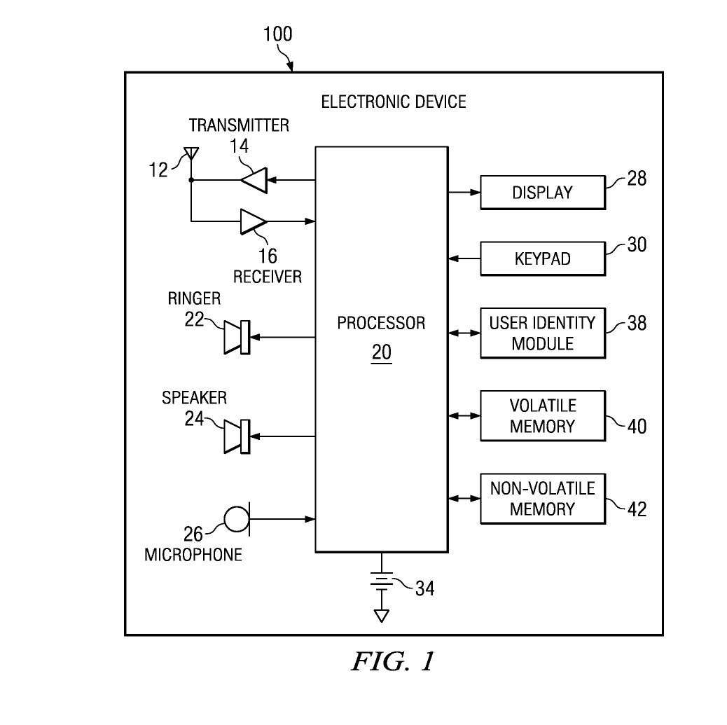

An example embodiment of the present invention and its potential advantages are best understood by referring to FIGS. 1 through 6 of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, the one or more output devices of the user interface may be coupled to the processor 20. In an example embodiment, the display 28 is a touch screen, liquid crystal display, and/or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

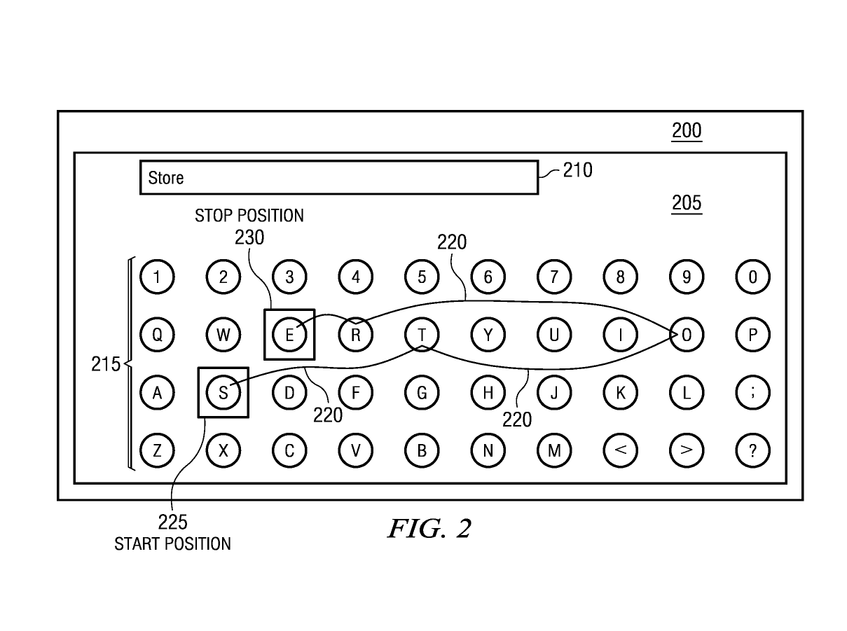

FIG. 2 is a block diagram depicting a shorthand-aided rapid keyboarding enabled touchscreen 205 operating in accordance with an example embodiment of the invention. In an example embodiment, an electronic device 200 comprises a user interface, such as shorthand-aided rapid keyboarding enabled touchscreen 205. The shorthand-aided rapid keyboarding enabled touchscreen 205 comprises a text input 210, one or more keys 215, a word path 220, a start position 225, and a stop position 230.

In an embodiment, the shorthand-aided rapid keyboarding 205 is configured to receive user input from at least one of the following: tablet, handheld PCs, computer, touchscreen, electronic device, and/or the like. In an example embodiment, shorthand-aided rapid keyboarding may be referred to as Shapewriter®. Using shorthand-aided rapid keyboarding text entry software, a user draws words on a graphical keyboard using a pen. In an embodiment, the user interface is configured to receive a user draw, such as a pen gesture, a finger motion, a stylus, and/or the like connecting one or more letters in a desired word.

In an example embodiment, shorthand-aided rapid keyboarding uses handwriting recognition. In an embodiment, handwriting recognition is the ability of a processor, such as processor 20 of FIG. 1, to receive and interpret intelligible handwritten input from sources such as paper documents, photographs, touch-screens and other devices. The image of the written text may be sensed “off line” from a piece of paper by optical scanning, such as optical character recognition, intelligent word recognition, and/or the like. In an alternative embodiment, user movements of the pen tip may be sensed “on line”, for example by a pen-based computer screen surface.

In an example embodiment, the shorthand-aided rapid keyboarding enabled touchscreen 205 is configured to receive a user input. In an example embodiment, the user input is a swiping movement. For example, a user swipes along a word path 220 to spell the word “store.” In an embodiment, the user input is at least one of the following: press, long press, hard press, combination thereof, and/or the like. For example, a user presses the “S” on the shorthand-aided rapid keyboarding enabled touchscreen 205. In another example, the user presses the “STOR” keys and changes the force when pressing the “E” key on the shorthand-aided rapid keyboarding enabled touchscreen 205. In such an example, the change in force represents the end of the word “STORE.”

In an example embodiment, a processor, such as processor 20 of FIG. 1, for the electronic device 200 is configured to identify a position in a text input 210 based at least in part on the user input. For example, the processor identifies when the user input begins, e.g., letter “S”, as a start position 225. Further, the processor identifies where the user input ends, e.g., pressing letter “E”, as a stop position 230.

In an example embodiment, the processor determines a non alphanumeric character based at least in part on the user input at the stop position 230. For example, a user presses the “e” key at the stop position 230. In an embodiment, the key press represents punctuation. For example, the key press represents a period, a question mark, an exclamation point, a symbol, or a combination thereof. In such a case, the shorthand-aided rapid keyboarding enabled touchscreen 205 is configured to display the non alphanumeric character in the text input 210, e.g., add a period. A technical effect of one or more of the example embodiments disclosed herein is adding a non alphanumeric character based at least in part on a user input.

In an alternative embodiment, the start position 225 and stop position 230 may be used to for word prediction. For example, the processor compares the letters of the path traversed and compares it to the options available in an internal dictionary as known in the art. In an embodiment, the internal dictionary may comprise user added words. In an embodiment, a second internal dictionary may exist with user added words. Further, internal dictionaries may be downloadable thereby allowing updates. Further still, internal dictionaries may provide a predictive language technique to calculate the next most probable matches of the word. In an alternative embodiment, the internal dictionaries may employ statistical analysis, e.g. which letters most probably follow a certain letter in English or other language to determine the word. In an example embodiment, the processor is configured to detect the first and last characters of a user press. The processor may match the user presses with the internal dictionary. For example, the processor may return a number of potential matches, such as store, stout, stir, sore, dure, and/or the like, based on the user input. Based at least in part on these potential matches, the processor may add the knowledge of which character was the first and last character, and hereby re-order or filter the list of matches so that the words starting with S and ending with E are listed first, e.g., for the word store.

Consider the following example. A user touches the start position 225 for a word, e.g., “S” for the word Store. The user may then traverse a path 220 including at least certain intermediate letters of the word, and then presses the stop position 230 of the word, e.g., the letter “E”. For example, a user enters the word “store” on path 220 by first pressing the letter “S,” traversing the finger toward the letter “T,” then the “0” and “R” before coming to rest on the letter “E” where the user presses the E key. In such a case, the shorthand-aided rapid keyboarding enabled touchscreen 205 displays the word “store” in the text input 210.

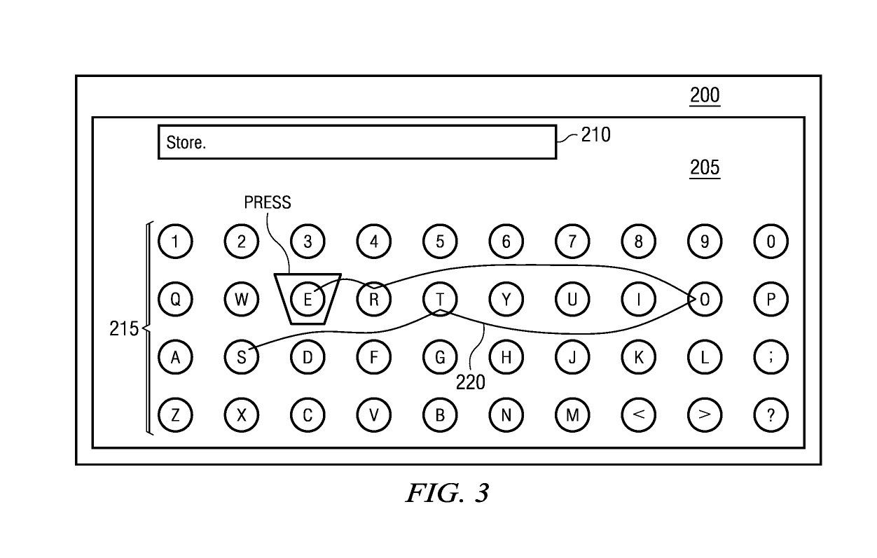

FIG. 3 is a block diagram depicting another shorthand-aided rapid keyboarding enabled touchscreen 205 operating in accordance with an example embodiment of the invention. In an example embodiment, an electronic device 200 comprises a user interface, such as shorthand-aided rapid keyboarding enabled touchscreen 205. The shorthand-aided rapid keyboarding enabled touchscreen 205 comprises a text input 210, one or more keys 215, and a word path 220.

In an example embodiment, the shorthand-aided rapid keyboarding enabled touchscreen 205 is configured to receive a user input. In an example embodiment, the user input is at least one of the following: press, long press, hard press, combination thereof, and/or the like. For example, the shorthand-aided rapid keyboarding enabled touchscreen 205 detects a press.

In an example embodiment, the processor determines a non alphanumeric character based at least in part on the user input, e.g., the press. For example, a user presses the “e” key. In an embodiment, the key press represents punctuation. For example, a period, a question mark, an exclamation point, a symbol, or a combination thereof. In such a case, the shorthand-aided rapid keyboarding enabled touchscreen 205 is configured to display the non alphanumeric character in the text input 210, e.g., add a period.

In an example embodiment, the shorthand-aided rapid keyboarding enabled touchscreen 205 detects a hard press.

In an embodiment, a hard press is related to force. In an example embodiment, the force may define a start or end of a word. In example above for the word “STORE” a user presses the screen harder when starts the swipe from “S” and reduces the force of pressure. The user presses the screen harder again when entering next word thereby indicating the end of the word “STORE.” In an alternative embodiment, the user presses with more force during of the word. For example, the user can swipes characters STOR normally and then press harder the screen when swiping over character E.

In an example embodiment, the user swipes words with same force of pressure, but changes the force, e.g., harder, lighter pressure, and/or the like, when moving from last character of a word to a first character to a next word thereby adding a space between words. In an alternative embodiment, the user may employ a touch-click. In an embodiment, a touch display has a mechanical moving display and a ‘dome’ underneath the touch display. The touch display is configured to allow distinguishing between ‘soft-swiping’ and pressing hard.

In an example embodiment, the processor determines a non alphanumeric character based at least in part on the user input, e.g., the hard press. For example, a user performs a hard press on the “e” key. In an embodiment, the hard press represents word completion. In an embodiment, the processor compares the letters of the path traversed and compares it to the options available in an internal dictionary as known in the art. In such a case, the shorthand-aided rapid keyboarding enabled touchscreen 205 is configured to display the completed word.

In an embodiment, the shorthand-aided rapid keyboarding enabled touchscreen 205 compries a capacitive sensor, a sense matrix, and/or the like disposed beneath the one or more keys 215. Further, the shorthand-aided rapid keyboarding enabled touchscreen 205 may contain an array of discrete key switches, as is known in the art, in addition to the capacitive sense matrix, or the sense matrix may be fashioned to be responsive to key activation force or changes in capacitance related to intentional key activation by a user. Thus, the shorthand-aided rapid keyboarding enabled touchscreen 205 may be configured to determine finger location and whether or not a key has been pressed. In an embodiment, a processor, such as processor 20 of FIG. 1, is configured to determine a key press, such as a non alphanumeric character or alphanumeric character, using signal intensity. The keys of the keypad may have independently movable, spaced-apart key caps, or the keys may comprise discrete regions of a single keypad surface, such as a flexible membrane.

In an example embodiment, the keypad is a QWERTY keyboard configuration. In an alternative embodiment, the keypad is an International Telecommunication Union (ITU)-T keypad. In an embodiment, the ITU-T keypad is the traditional mobile device keypad comprising 12 basic keys, that is, number key 0-9, *-key and #-key. ITU-T is a standard of International Telecommunication Union. Other configurations are also possible.

In an embodiment, the shorthand-aided rapid keyboarding enabled touchscreen 205 may be configured to determine signal intensity as based at least in part on a user's finger elevation above the surface of the shorthand-aided rapid keyboarding enabled touchscreen 205 with respect to time. In an embodiment, the shorthand-aided rapid keyboarding enabled touchscreen 205 may be calibrated to the user's finger size as a key is pressed, thereby providing a measurement of signal strength to finger distance. In an embodiment, signal intensity increases as the user presses the “S, T, O, R” keys, remains relatively constant during a standard “traverse” and then increases again as the user presses the “E.”

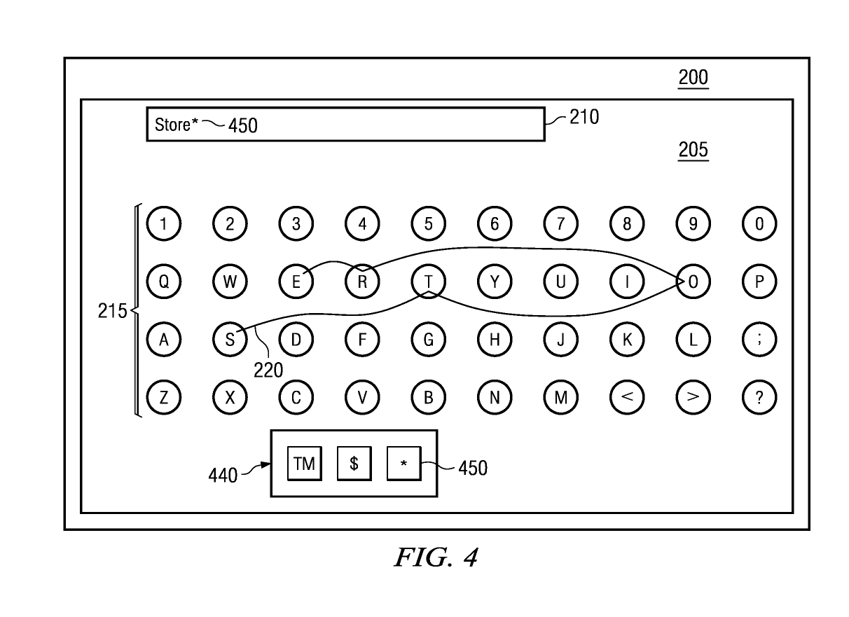

FIG. 4 is a block diagram depicting yet another shorthand-aided rapid keyboarding 205 enabled touchscreen operating in accordance with an example embodiment of the invention. In an example embodiment, an electronic device 200 comprises a user interface, such as shorthand-aided rapid keyboarding enabled touchscreen 205. The shorthand-aided rapid keyboarding enabled touchscreen 205 comprises a text input 210, one or more keys 215, and a word path 220.

In an example embodiment, an electronic device 200 comprises a user interface, such as shorthand-aided rapid keyboarding enabled touchscreen 205. The shorthand-aided rapid keyboarding enabled touchscreen 205 comprises a text input 210, one or more keys 215, and a word path 220. In an example embodiment, the shorthand-aided rapid keyboarding enabled touchscreen 205 is configured to receive a user input. In an example embodiment, the user input is at least one of the following: press, long press, hard press, combination thereof, and/or the like. In an alternative embodiment, the shorthand-aided rapid keyboarding enabled touchscreen 205 is configured to detect a finger press or touch. Further, the shorthand-aided rapid keyboarding enabled touchscreen 205 may be further configured to detect the area of the finger press or touch. In such a case, the shorthand-aided rapid keyboarding enabled touchscreen 205 detects the key based at least in part on the area of the finger press or touch.

In an example embodiment, the shorthand-aided rapid keyboarding enabled touchscreen 205 is configured to receive a user input. In an example embodiment, the user input is at least one of the following: press, long press, hard press, combination thereof, and/or the like. For example, the shorthand-aided rapid keyboarding enabled touchscreen 205 detects a long press.

In an example embodiment, the user interface displays one or more special characters, such as a symbol, trademark designation, and/or the like. For example, a user presses the “e” key and the user interface displays a special character menu 440. In an embodiment, the user may select a special character 450. In an embodiment, the shorthand-aided rapid keyboarding enabled touchscreen 205 is configured to display the special character 450 in the text input 210. In an embodiment, the non alphanumeric character is displayed while a user continuously touches the shorthand-aided rapid keyboarding enabled touchscreen. In an alternative embodiment, the special character menu 440 is displayed if a user motion passes over a shape associated with the special character menu 440. In another alternative embodiment, the special character 450 may be selected if a user moves over a special character 450 located on the user interface, e.g., on the keyboard and not a separate menu.

In an example embodiment, the shorthand-aided rapid keyboarding enabled touchscreen 205 is configured to receive a user input. In an example embodiment, the user input is a swipe over one or more numbers on, for example, an ITU-T keypad. For example, the user swipes over five numbers for a zip code. In an alternative embodiment, the ITU-T keypad may be used for inputting words. For example, a user selects a letter mode on the ITU-T keypad and swipes numbers in letter mode. In an embodiment, the swiped numbers may be matched in an internal dictionary, such as a predictive text entry works, e.g., 7-8-6-7-3 represents the word “store.” It should be understood that embodiments of the invention may employ a QWERTY keypad, an ITU-T keypad, other keypads, and/or the like.

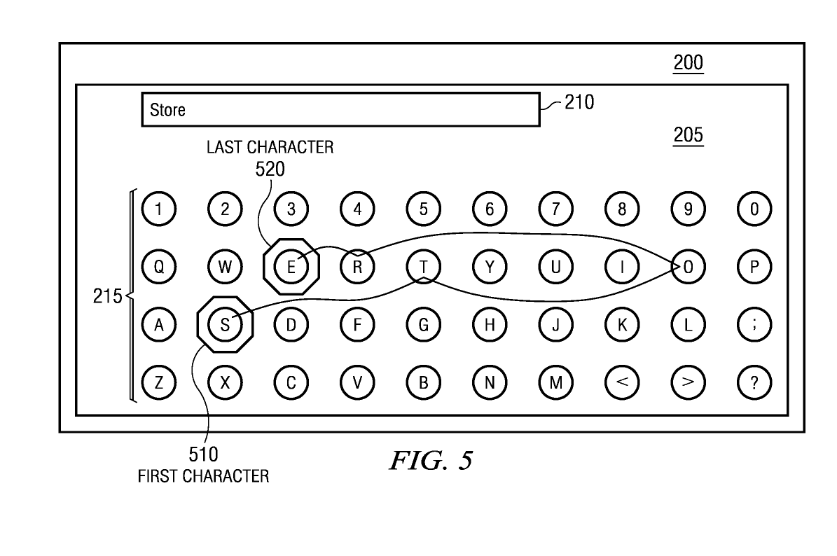

FIG. 5 is a block diagram depicting still yet another shorthand-aided rapid keyboarding enabled touchscreen 205 operating in accordance with an example embodiment of the invention. In an example embodiment, the shorthand-aided rapid keyboarding enabled touchscreen 205 is configured to receive a user input. In an example embodiment, the user input is a swiping motion. For example, the shorthand-aided rapid keyboarding enabled touchscreen 205 detects a user swipe.

In an example embodiment, the processor determines a non alphanumeric character based at least in part on the user input, e.g., the swipe. For example, a user swipes the word “store.” In an example embodiment, a processor, such as processor 20 of FIG. 1, a processor is configured to mark a first character 510 based at least in part on the user input. For example, the processor marks the letter “S” as the first character 510. The processor may also mark a last character 520 based at least in part on the user input. For example, the processor marks the letter “E” as the last character 520. The processor is configured to determine accuracy of the word based at least in part on the first word character and the last word character. In an example embodiment, the processor is configured to use an internal dictionary. A technical effect of one or more of the example embodiments disclosed herein is improved accuracy using a shorthand-aided rapid keyboarding enabled touchscreen

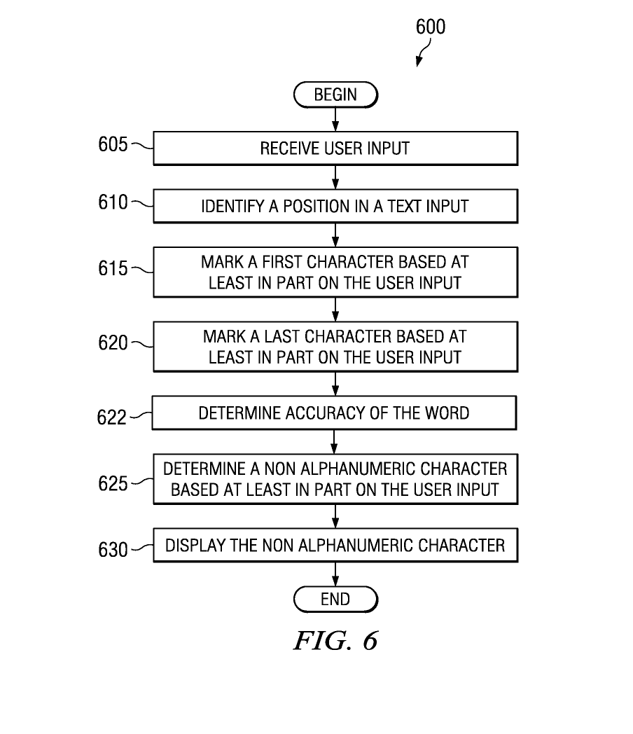

FIG. 6 is a flow diagram depicting an example method 600 for display a non alphanumeric character in accordance with an example embodiment of the invention. Example method 600 may be performed by an electronic device, such as electronic device 100 of FIG. 1.

At 605, a user input is received. In an example embodiment, a keypad, such as shorthand-aided rapid keyboarding 200 of FIG. 2, is configured to receive a user input. In an example embodiment, the user input is a swiping movement. For example, a user swipes along a word path, such as word path 220 of FIG. 2, to spell the word “store.” In an embodiment, the user input is at least one of the following: press, long press, hard press, combination thereof, and/or the like. For example, a user presses the “S” on the keypad.

At 610, a position in a text input based at least in part on the user input is identified. In an example embodiment, the processor is configured to identify a position in a text input, such as text input 210 of FIG. 2, based at least in part on the user input. For example, the processor identifies when the user input begins, e.g., letter “S”, as a start position. Further, the processor identifies where the user input ends, e.g., pressing letter “E”, as a stop position for the word “STORE.”

At 615, a first character is marked based at least in part on the user input. In an example embodiment, the processor is configured to mark the first character based at least in part on the user input. For example, the processor marks the letter “S” as the first character for the word “store.”

At 620, a last character is marked based at least in part on the user input. In an example embodiment, the processor marks the last character based at least in part on the user input. For example, the processor is configured to mark the letter “E” as the last character for the word “store.”

At 622, accuracy of the word is determined. In an embodiment, the processor is configured to determine accuracy of the word based at least in part on the first word character and the last word character. For example, the processor uses an internal dictionary to verify the accuracy of the user inputted word.

At 625, a non alphanumeric character is determined based at least in part on the user input. In an example embodiment, the processor determines a non alphanumeric character based at least in part on the user input. For example, a user presses the “e” key. In an embodiment, the key press represents punctuation. For example, the key press represents a period, a question mark, an exclamation point, a symbol, or a combination thereof.

At 630, the non alphanumeric character is displayed. In an example embodiment, the shorthand-aided rapid keyboarding enabled touchscreen is configured to display the non alphanumeric character, e.g., a period.

Without in any way limiting the scope, interpretation, or application of the claims appearing below, a technical effect of one or more of the example embodiments disclosed herein may be improved accuracy using a shorthand-aided rapid keyboarding enabled touchscreen. Another technical effect of one or more of the example embodiments disclosed herein may be adding a non alphanumeric character based at least in part on a user input.

Embodiments of the present invention may be implemented in software, hardware, application logic or a combination of software, hardware and application logic. The software, application logic and/or hardware may reside on an electronic device or a service. If desired, part of the software, application logic and/or hardware may reside on an electronic device and part of the software, application logic and/or hardware may reside on a service. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a shorthand-aided rapid keyboarding enabled touchscreen configured to:
receive a user input;
a processor configured to:
identify a position in a text input; and
determine a non alphanumeric character based at least in part on the user input; and
the shorthand-aided rapid keyboarding enabled touchscreen further configured to:
display the non alphanumeric character in the position.

2. The apparatus of claim 1 wherein the user input is a swiping movement.

3. The apparatus of claim 1 wherein the user input is at least one of the following: press, long press, hard press, or combination thereof.

4. The apparatus of claim 1 wherein the non alphanumeric character is at least one of the following: a period, a question mark, an exclamation point, a symbol, or a combination thereof.

5. The apparatus of claim 1 wherein the identify a position in a text input further comprises the processor configured to:
mark a first character based at least in part on the user input; and
mark a last character based at least in part on the user input.

6. The apparatus of claim 5 wherein the marked first character and last character is a first word character and a last word character for a word.

7. The apparatus of claim 6 wherein the processor is further configured to determine accuracy of the word based at least in part on the first word character and the last word character.

8. The apparatus of claim 1 wherein the non alphanumeric character is displayed while a user continuously touches the shorthand-aided rapid keyboarding enabled touchscreen.

9. The apparatus of claim 1 wherein the processor is configured to determine a non alphanumeric character using signal intensity.

10. The apparatus of claim 1 wherein the apparatus is at least one of the following: an electronic device or a computer.

11. The apparatus of claim 1, wherein the processor comprises at least one memory that contains executable instructions that if executed by the processor cause the apparatus to identify a position in a text input; and determine a non alphanumeric character based at least in part on the user input.

12. A method, comprising:
receiving a user input on a shorthand-aided rapid keyboarding;
identifying a position in a text input;
determining a non alphanumeric character based at least in part on the user input; and
displaying the non alphanumeric character in the position on the shorthand-aided rapid keyboarding enabled touchscreen.

13. The method of claim 12 wherein the user input is a swiping movement.

14. The method of claim 12 wherein the user input is at least one of the following: press, long press, hard press or combination thereof.

15. The method of claim 12 wherein the non alphanumeric character is at least one of the following: a period, a question mark, an exclamation point, a symbol, or a combination thereof.

16. The method of claim 12 wherein the identifying a position in a text input further comprises:
marking a first character based at least in part on the user input; and
marking a last character based at least in part on the user input.

17. The method of claim 16 wherein the marked first character and last character is a first word character and a last word character for a word.

18. The method of claim 17 further comprising determining determine accuracy of the word based at least in part on the first word character and the last word character.

19. The method of claim 12 wherein the non alphanumeric character is displayed while a user continuously touches the shorthand-aided rapid keyboarding enabled touchscreen.

20. The method of claim 12 further comprises determining a non alphanumeric character using signal intensity.

21. The apparatus as in any of claims 3-11 wherein the user input is a swiping movement.

22. The apparatus as in any of claim 2 or 4-11 wherein the user input is at least one of the following: press, long press, hard press, or combination thereof.

23. The apparatus as in any of claim 2-3 or 5-11 wherein the non alphanumeric character is at least one of the following: a period, a question mark, an exclamation point, a symbol, or a combination thereof.

24. The apparatus as in any of claim 2-4 or 6-11 wherein the identify a position in a text input further comprises the processor configured to:
mark a first character based at least in part on the user input; and
mark a last character based at least in part on the user input.

25. The apparatus as in any of claim 2-7 or 9-11 wherein the non alphanumeric character is displayed while a user continuously touches the shorthand-aided rapid keyboarding enabled touchscreen.

26. The apparatus as in any of claim 2-8 or 10-11 wherein the processor is configured to determine a non alphanumeric character using signal intensity.

27. The apparatus as in any of claim 2-9 or 11 wherein the apparatus is at least one of the following: an electronic device or a computer.

28. The method as in any of claims 14-20 wherein the user input is a swiping movement.

29. The method as in any of claim 13 or 15-20 wherein the user input is at least one of the following: press, long press, hard press or combination thereof.

30. The method as in any of claim 13-14 or 16-20 wherein the non alphanumeric character is at least one of the following: a period, a question mark, an exclamation point, a symbol, or a combination thereof.

31. The method as in any of claim 13-15 or 17-20 wherein the identifying a position in a text input further comprises:
marking a first character based at least in part on the user input; and
marking a last character based at least in part on the user input.

32. The method as in any of claim 13-18 or 20 wherein the non alphanumeric character is displayed while a user continuously touches the shorthand-aided rapid keyboarding enabled touchscreen.

33. The method as in any of claims 13-19 further comprises determining a non alphanumeric character using signal intensity.

34. A computer program product comprising a computer-readable medium bearing computer program code embodied therein for use with a computer, the computer program code comprising:
code for receiving a user input on a shorthand-aided rapid keyboarding;
code for identifying a position in a text input;
code for determining a non alphanumeric character based at least in part on the user input; and
code for displaying the non alphanumeric character in the position on the shorthand-aided rapid keyboarding enabled touchscreen.

35. A computer-readable medium encoded with instructions that, when executed by a computer, perform:
receiving a user input on a shorthand-aided rapid keyboarding;
identifying a position in a text input;
determining a non alphanumeric character based at least in part on the user input; and
displaying the non alphanumeric character in the position on the shorthand-aided rapid keyboarding enabled touchscreen.
